(19) United States
(12) Patent Application Publication
(10) Pub. No.: US 2025/0229510 A1
(43) Pub. Date: Jul. 17, 2025

(54) COMPOSITE STRUCTURE AND ITS PREPARATION METHOD AND USE

(71) Applicant: Leica Biosystems Nussloch GmbH, Nussloch (DE)

(72) Inventors: Lester LU, Shanghai (CN); Ming WU, Shanghai (CN); Lisa LI, Shanghai (CN); Yong LIANG, Shanghai (CN)

(21) Appl. No.: 18/727,942

(22) PCT Filed: Jan. 25, 2022
(86) PCT No.: PCT/CN2022/073613

§ 371 Date: Jul. 10, 2024

(51) Int. Cl. B32B 27/08; B32B 3/02; B32B 17/06

(52) U.S. Cl. CPC B32B 27/08; B32B 3/02; B32B 17/06; B32B 2255/10; B32B 2307/402; B32B 2307/412; B32B 2307/75; B32B 2315/08; B32B 2398/20

(57) ABSTRACT

A composite structure includes: a substrate, and a printable layer, provide on at least a part of a surface of the substrate and having accommodated therein a colorful material.

### CROSS-REFERENCE TO RELATED APPLICATION

This application is a U.S. national phase application of International Application No. PCT/CN2022/073613, filed Jan. 25, 2022, the entire contents of which are incorporated herein by reference.

### TECHNICAL FIELD

The present disclosure relates to a composite structure, and more particularly to a composite structure for a laser printing system, a method for producing the same and use of the same in laser printing.

### BACKGROUND

An existing slide usually only includes a glass substrate and a colorful coating layer, which cannot be used in laser printing, because during the printing, a part of the colorful coating layer will be ablated by a laser of the laser printing system to release harmful substances, such as harmful gas, fume or particles, which will damage human health and pollute the environment. Further, the released substances will adhere to a surface of a lens of the laser printing system to block the light path, and they also may accumulate in the laser printing system, thereby affecting the performance of the laser printing system.

To prevent the harmful substances from diffusing and accumulating in the laser printing system, an air-forced ventilation is envisaged. To prevent the harmful substances from polluting the air, a filter usually needs to be put at the end of the designed air flue. However, the additional purification system has the following disadvantages or deficiencies: (1) the air flue and the filter occupy space and will inevitably enlarge the size of the laser printing device; (2) if the air force of the purification system is not strong enough, the fume or particles generated by laser ablation will still adhere to the surface of lens to block the light path; (3) the bad smell caused by the laser ablation can hardly be filtered by the filter; (4) the fume or particle can hardly be filtered completely, so that the fume and particles will still pollute the air; (5) the filter has a limited service life and should be replaced regularly; (6) the additional purification system and the frequent replacement of the filter will inevitably increase the cost of the laser printing system.

### SUMMARY

Embodiments of the present disclosure seek to solve at least one of the problems existing in the related art to at least some extent.

According to a first aspect of embodiments of the present disclosure, there is provided a composite structure. The composite structure includes: a substrate, and a printable layer provide on at least a part of a surface of the substrate and having accommodated therein a colorful material.

In some embodiments, the colorful material is covered by the printable layer.

In some embodiments, the colorful material is dispersed in the printable layer.

In some embodiments, the printable layer includes: a coating layer, including the colorful material and provided on the at least a part of the surface of the substrate; and a cover layer, including a transparent material and provided on a surface of the coating layer opposite to the substrate.

In some embodiments, an orthographic projection of the coating layer on the surface of the substrate is overlapped exactly with that of the cover layer on the surface of the substrate.

In some embodiments, an orthographic projection of the coating layer on the surface of the substrate is within that of the cover layer on the surface of the substrate.

In some embodiments, at least a part of a periphery of the cover layer extends beyond the coating layer to the surface of the substrate.

In some embodiments, at least a part of a periphery of the cover layer extends to a thickness direction of the substrate.

In some embodiments, at least a part of a periphery of the coating layer is aligned with or close to a corresponding part of a periphery of the substrate.

In some embodiments, the printable layer is aligned with or close to one of two opposite ends of the substrate, and is far away from the other one of the two opposite ends of the substrate.

In some embodiments, the transparent material is one or more selected from a UV glue, a silicone oil, glass, and a thermoplastic.

In some embodiments, the cover layer is adhered to the coating layer.

In some embodiments, the colorful material has a light color.

In some embodiments, the colorful material has a white, pink, yellow or green color.

In some embodiments, the substrate is transparent.

In some embodiments, the substrate is a glass substrate or plastic substrate.

According to a second aspect of embodiments of the present disclosure, there is provided a method for producing the composite structure as described above. The method includes: providing a substrate; and providing a printable layer on at least a part of a surface of the substrate. The printable layer has accommodated therein a colorful material.

In some embodiments, providing the printable layer on at least a part of the surface of the substrate includes: dispersing the colorful material in a transparent material; and painting a mixture of the colorful material and the transparent material on at least a part of the surface of the substrate.

In some embodiments, the printable layer includes a coating layer and a cover layer, and providing the printable layer on at least a part of the surface of the substrate includes: providing the colorful material on the at least a part of the surface of the substrate to form the coating layer; and providing the transparent material on the surface of the coating layer opposite to the substrate to form the cover layer.

According to a third aspect of embodiments of the present disclosure, there is provided use of the composite structure as described above in laser printing. A part of the colorful material contained in the printable layer, when illuminated by a laser of a laser printing system, is ablated to generate printed content.

In some embodiments, the laser printing system is an infrared laser printing system or a UV laser printing system.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a schematic perspective view of a composite structure according to an embodiment of the present disclosure.

FIG. 2 is a schematic sectional view of a composite structure according to an embodiment of the present disclosure.

FIG. 3 is a schematic sectional view of a composite structure according to an embodiment of the present disclosure.

FIG. 4 is a schematic sectional view of a composite structure according to an embodiment of the present disclosure.

FIG. 5 is a schematic sectional view of a composite structure according to an embodiment of the present disclosure.

FIG. 6 is a schematic diagram showing comparison of the print performance between an existing slide and a slide according to an embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

In a first aspect of embodiments of the present disclosure, there is provided a composite structure. The composite structure includes a substrate, and a printable layer provided on at least a part of a surface of the substrate. The printable layer has accommodated therein a colorful material.

The printable layer is transparent, and when the composite structure is subjected to a laser, the printable layer allows the laser to reach the colorful material accommodated therein, and a part of the colorful material illuminated by the laser will be ablated to generate printed content as required. At the same time, as the colorful material is accommodated in the printable layer, gas, fume or particles generated by the ablation of the colorful material will be blocked in the printable layer and thus cannot escape from the printable layer to the air, thereby protecting the health of an operator and protecting the environment. Therefore, the composite structure according to embodiments of the present disclosure is applicable to laser printing.

In some embodiments of the present disclosure, the colorful material may be dispersed in the printable layer, so as to lock the colorful material in the transparent material. In this way, when a part of the colorful material is ablated by the laser, most of the generated gas, fume or particles will be locked by the printable layer and thus cannot escape from the printable layer to the air, so as to protect the health of an operator and protect the environment.

In some embodiments of the present disclosure, the printable layer includes a transparent material, and the colorful material is dispersed in the transparent material.

In some embodiments of the present disclosure, the colorful material may be covered by the printable layer. In this way, when a part of the colorful material is ablated by the laser, most of the generated gas, fume or particles will be isolated within the printable layer and thus cannot escape from the printable layer to the air, so as to protect the health of an operator and protect the environment.

In some embodiments of the present disclosure, the colorful material may be embedded in the printable layer. In this way, when a part of the colorful material is ablated by the laser, the generated gas, fume or particles will be sealed by the printable layer and thus cannot escape from the printable layer to the air, so as to protect the health of an operator and protect the environment.

In some embodiments of the present disclosure, the printable layer includes a coating layer and a cover layer. The coating layer includes the colorful material and is provided on the at least a part of the surface of the substrate. The cover layer includes the transparent material and is provided on a surface of the coating layer opposite to the substrate.

The coating layer may serve as a laser printable area. During the printing, a part of the coating layer will be ablated by the laser to print the content as required on the coating layer, with the generation of gas, fume or particles. As the coating layer is covered by the cover layer, these harmful substances will be prevented from releasing to the outside, thereby protecting the health of an operator and protecting the environment.

In some embodiments, an orthographic projection of the coating layer on the surface of the substrate is overlapped exactly with that of the cover layer on the surface of the substrate. That is, the cover layer has the same size and shape as that of the coating layer, such that the coating layer is located directly under the cover layer and covered by the cover layer completely.

In some embodiments, an orthographic projection of the coating layer on the surface of the substrate is within that of the cover layer on the surface of the substrate. That is, the cover layer has a greater size than that of the coating layer, and at least a part of the cover layer extends beyond the coating layer to make sure that the coating layer is completely covered by the cover layer.

In some embodiments, at least a part of a periphery of the cover layer extends beyond the coating layer to the surface of the substrate. In some embodiments, all the periphery of the cover layer extends beyond the coating layer to the surface of the substrate, such that the coating layer is completely wrapped by the cover layer, and thus the harmful gas, fume or particles generated by ablation in the printing process is sealed completely by the cover layer, and cannot be released to air, so as to protect the health of the operator and protect the environment.

In some embodiments, at least a part of a periphery of the cover layer extends to a thickness direction of the substrate, so as to make sure that even the coating layer at a periphery of the substrate is still sealed by the cover layer to make the coating layer completely wrapped by the cover layer, thereby preventing the harmful gas, fume or particles generated by ablation in the printing process from releasing to air.

In some embodiments, at least a part of a periphery of the printable layer is close to a corresponding part of the periphery of the substrate. In some embodiments, at least a part of a periphery of the coating layer is close to a corresponding part of the periphery of the substrate. For example, at least one edge of the coating layer is close to a corresponding edge of the substrate. In some embodiments, two opposite edges of the coating layer extending in a length direction of the substrate are close to corresponding edges of the substrate. In some embodiments, three adjacent edges of the coating layer are close to corresponding edges of the substrate.

In some embodiments, at least a part of a periphery of the printable layer is aligned with a corresponding part of the periphery of the substrate. In some embodiments, at least a part of a periphery of the coating layer is aligned with a corresponding part of the periphery of the substrate. For example, at least one edge of the coating layer is aligned with a corresponding edge of the substrate. In some embodiments, two opposite edges of the coating layer extending in the length direction of the substrate are aligned with corresponding edges of the substrate. In some embodiments, three adjacent edges of the coating layer are aligned with corresponding edges of the substrate.

In embodiments of the present disclosure, the printable layer has a high transmittance. In some embodiments, the cover layer has a high transmittance. For example, the transmittance of the printable layer or the cover layer may be at least ≥80%, such as ≥80%, ≥85%, ≥90%, ≥92%, ≥95%, ≥96%, ≥97%, ≥98%, ≥99%, ≥99.5% or almost 100%. Therefore, when a laser is applied to the composite structure, the cover layer substantially does not react with the laser, so there is no harmful substance generated thereby, and the high transmittance of the cover layer enables most of the laser to pass therethrough to reach the coating layer without significant attenuation of the energy, so as to ensure that the coating layer can be ablated by the laser effectively to generate the content as required.

In some embodiments of the present disclosure, the cover layer may be made of any transparent material with high transmittance, which may be selected from, but not limited to, a UV glue, a silicone oil, glass, and a thermoplastic. The thermoplastic includes, but is not limited to polymethyl methacrylate (PMMA), polycarbonate (PC), polyethylene glycol terephthalate (PET), polyvinyl chloride (PVC) and the like. The transparent material can be selected by those skilled in the art as required. It will be appreciated that these transparent materials are commercially available. For example, the UV glue is commercially available as Surgipath Solution B with the Material number 39475272 from Richmond.

In some embodiments of the present disclosure, the cover layer may have a smooth surface, such that the energy of the laser dose not attenuate significantly after passing through the cover layer.

In some embodiments of the present disclosure, the cover layer may be adhered to the coating layer to improve the stability of the composite structure and at the same time to enable the cover layer to capture the gas, fume or particles generated during the printing firmly. In other words, the adhesive force between the cover layer and the coating layer is large enough to capture the generated gas, fume or particles and keep the integrity of the composite structure during the printing. For example, if the cover layer has a viscidity per se or is viscous, for example, the cover layer is made of the UV glue, the cover layer can be adhered to the coating layer by taking advantage of the viscidity itself. If the cover layer has no viscidity per se or is non-viscous, for example, the cover layer is made of the glass, the cover layer can be adhered to the coating layer via a transparent adhesive. In this way, the cover layer can be adhered to the coating layer firmly, so as to ensure that the cover layer can withstand the impact of ejected gas, fume or particles during the printing.

In some embodiments of the present disclosure, the coating layer may be any lacquer layer ablatable by the laser, and the color of the coating layer is not specifically limited herein, which can be selected by those skilled in the art as required. In some embodiments, the coating layer has a light color, such as white, pink, yellow, green, etc.

In some embodiments of the present disclosure, the coating layer may be painted directly on the surface of the substrate.

In embodiments of the present disclosure, the substrate is transparent. For example, the substrate may be made of any transparent material, such as glass or a transparent polymer material. The transparent polymer material may include, but is not limited to, polymethyl methacrylate (PMMA), polycarbonate (PC), polyethylene glycol terephthalate (PET), polyvinyl chloride (PVC) and the like. Therefore, the substrate may be a glass substrate or a transparent polymer substrate. Therefore, when the composite structure according to embodiments of the present disclosure is used as a slide for preparation and analysis of a sample, it is conducive to the observation of the sample under an analysis instrument.

It should be illustrated that the size and the shape of the substrate are not particularly limited herein, which can be determined by those skilled in the art as required. For example, the substrate may be rectangular. Depending on the shape of the substrate, those skilled in that can adjust the shape of the printable layer to make it adapt to that of the substrate.

In addition, the printable layer is not limited to a particularly size herein, which can be determined by those skilled in the art based on the size of the substrate and their needs. In some embodiments, the printable layer may be as thin as possible, such that the laser does not attenuate much after passing therethrough. In some embodiments, the cover layer may be as thin as possible, such that the laser does not attenuate much after passing therethrough.

The composite structure according to embodiments of the present disclosure has the following technical advantages:
(1) when printing with the composite structure according to embodiments of the present disclosure, substantially no gas, fume or particles generated by the ablation of the coating layer during the printing can be released outside the cover layer, thereby protecting the health of the operator and protecting the environment;
(2) it is unnecessary to introduce an additional purification system to the laser printing system, which is beneficial to miniaturization of the laser printing system and beneficial to reduction of cost;
(3) with the cover layer, the fume or particles generated by the laser ablation will be locked and accumulated between the coating layer and the cover layer, and the accumulated fume or particles will make the printed content darker.

In a second aspect of embodiments of the present disclosure, there is provided a method for producing a composite structure as described in any embodiments hereinbefore. The method includes: providing a substrate; and providing a printable layer on at least a part of a surface of the substrate. The printable layer has accommodated a colorful material therein.

In some embodiments of the present disclosure, providing the printable layer on at least a part of the surface of the substrate includes:
dispersing the colorful material in a transparent material; and
painting a mixture of the colorful material and the transparent material on at least a part of the surface of the substrate.

In some embodiments of the present disclosure, the printable layer includes a coating layer and a cover layer. Providing the printable layer on at least a part of the surface of the substrate includes: providing the colorful material on the at least a part of the surface of the substrate to form the coating layer; and providing the transparent material on the surface of the coating layer opposite to the substrate to form the cover layer.

In some embodiments of the present disclosure, the coating layer and the cover layer are provided in such a way that an orthographic projection of the coating layer on the surface of the substrate is overlapped exactly with that of the cover layer on the surface of the substrate.

In some embodiments of the present disclosure, the coating layer and the cover layer are provided in such a way that an orthographic projection of the coating layer on the surface of the substrate is within that of the cover layer on the surface of the substrate.

In some embodiments of the present disclosure, the cover layer is provided in such a way that at least a part of a periphery of the cover layer extends beyond the coating layer to the surface of the substrate.

In some embodiments of the present disclosure, the cover layer is provided in such a way that at least a part of a periphery of the cover layer extends to a thickness direction of the substrate.

In some embodiments of the present disclosure, the cover layer is provided in such a way that at least a part of a periphery of the printable layer is aligned with or close to a corresponding part of a periphery of the substrate.

It will be appreciated that the descriptions and explanations made above with respect to embodiments of the composite structure are also applicable to the method, which will not be elaborated here.

In a third aspect of embodiments of the present disclosure, there is provided use of the composite structure as describe in any embodiments hereinbefore in laser printing. A part of the colorful material contained in the printable layer, when illuminated by a laser of a laser printing system, will be ablated by the laser to generate printed content.

It will be appreciated to those killed in the art that, the composite structure is suitable to any laser printing system, such as an infrared laser printing system and a UV laser printing system.

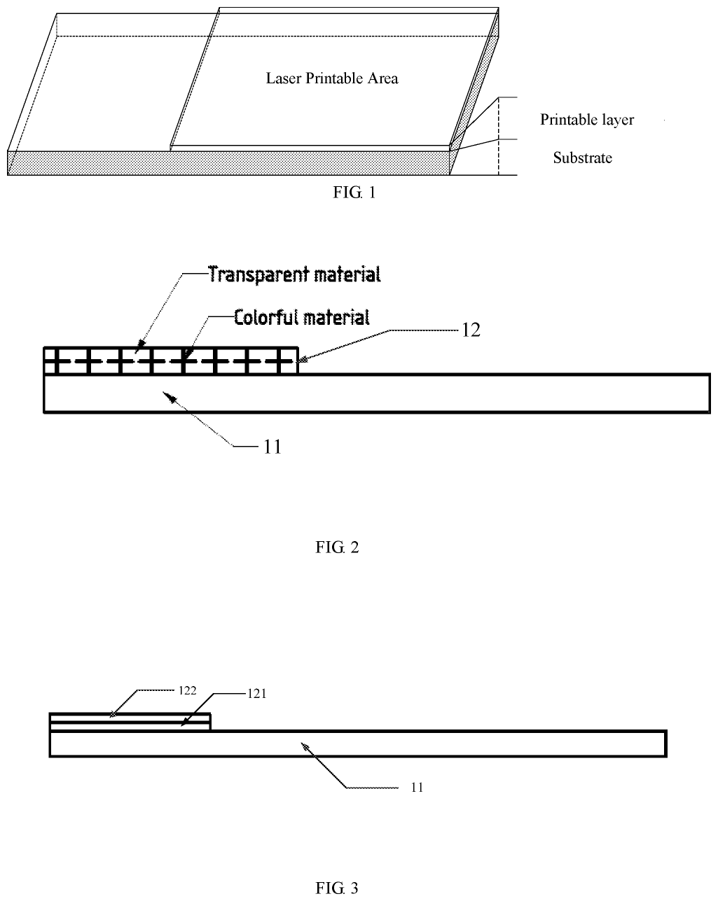

For easy of understanding, in the following, some examples of the composite structure according to embodiments of the present disclosure will be described in detail referring to FIG. 1 to FIG. 5.

As illustrated in FIG. 1 and FIG. 2, a composite structure includes a substrate 11 and a printable layer 12. The printable layer 12 is provide on at least a part of a surface of the substrate 11 and has accommodated therein a colorful material.

The colorful material may be dispersed in, covered by or embedded in the printable layer 12, so that the colorful material may be locked by the printable layer 12.

As illustrated in FIG. 2, the printable layer 12 includes a transparent material, and the colorful material is dispersed in the transparent material.

As illustrated in FIG. 3, the composite structure includes a substrate 11 and a printable layer 12. The printable layer 12 includes a coating layer 121 and a cover layer 122. The coating layer 121 is provide on a part of a surface of the substrate 11. The cover layer 122 is transparent and is provided on a surface of the coating layer 121 opposite to the substrate 11. An orthographic projection of the coating layer 121 on the surface of the substrate 11 is exactly overlapped with that of the cover layer 122 on the surface of the substrate 11, which means that the coating layer 121 is completely covered by the cover layer 122. In this way, the harmful gas, fume or particles generated by ablation in the printing process is completely sealed by the cover layer 122 and cannot escape from the printable layer 12 at all, so as to protect the health of the operator and protect the environment.

In some embodiments, for example, the printable layer 12 is aligned with the substrate 11 at a left end, but is far away from a right end of the substrate 11. In this way, when the composite structure is used as a slide for preparation and analysis of a sample, the composite structure can provide an enough area to support the sample.

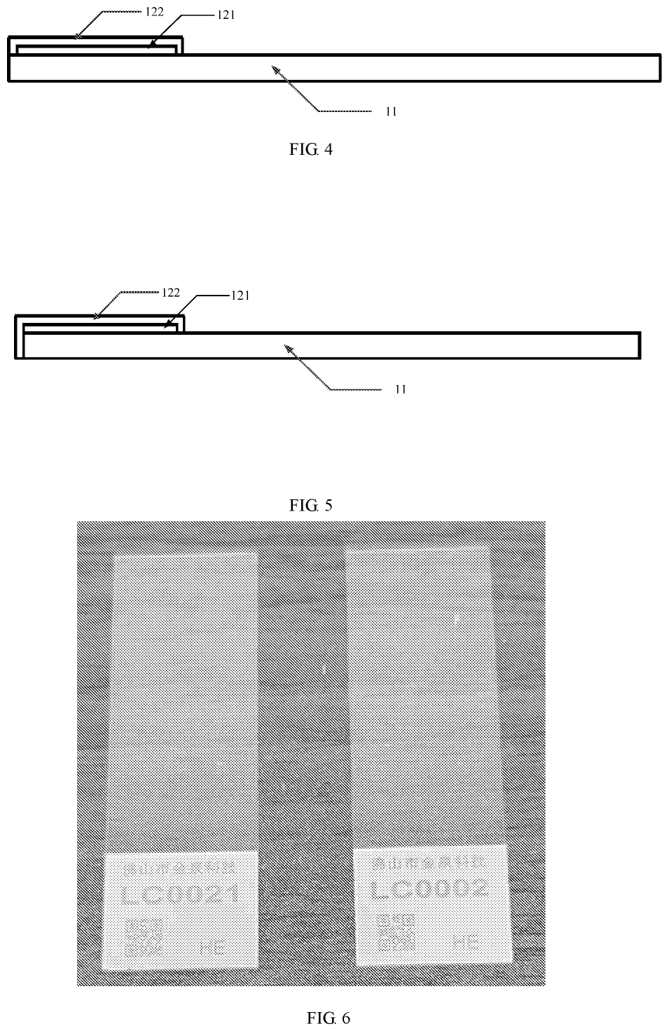

In some embodiments, as illustrated in FIG. 4, the composite structure includes a substrate 11 and a printable layer 12. The printable layer 12 includes a coating layer 121 and a cover layer 122. The cover layer 122 is transparent and is provided on a part of a surface of the substrate 11. The coating layer is provided between the substrate 11 and the cover layer 122. An orthographic projection of the coating layer 121 on the surface of the substrate 11 falls within that of the cover layer 122 on the surface of the substrate 11, indicating that the coating layer 121 is completely covered by the cover layer 122 or embedded in the cover layer 122.

In some embodiments, a periphery of the cover layer 122 extends beyond the coating layer 121 to the surface of the substrate, which means that the coating layer 121 is completely wrapped by the cover layer 122 and the substrate 11. In this way, the harmful gas, fume or particles generated by ablation in the printing process is completely sealed by the cover layer 122 and cannot escape from the coating layer at all, so as to protect the health of the operator and protect the environment.

In some embodiments, as shown in FIG. 4, a left end of the coating layer 121 is close to a left end of the substrate 11, and a right end of the cover layer 122 is far away from a right end of the substrate 11. In this way, when the composite structure is used as a slide for preparation and analysis of a sample, the composite structure can provide an enough area to support the sample.

In some embodiments, as illustrated in FIG. 5, the composite structure includes a substrate 11, and a printable layer 12. The printable layer 12 includes a coating layer 121, and a cover layer 122. The coating layer 121 is provide on a part of a surface of the substrate 11, and a left edge of the coating layer 121 is aligned with a left edge of the substrate 11, for example. The cover layer 122 is provided on a surface of the coating layer 121 opposite to the substrate 11, a left edge of the cover layer 122 extends to a thickness direction of the substrate 11, and a right edge of the cover layer 122 extends in a length direction of the substrate 13 to the surface of the substrate 11, such that an orthographic projection of the coating layer 121 on the surface of the substrate 11 falls within that of the cover layer 122 on the surface of the substrate 11, and the coating layer 121 is completely sealed by the cover layer 122. In this way, the harmful gas, fume or particles generated by ablation in the printing process cannot escape from the coating layer, so as to protect the health of the operator and protect the environment. Further, the right edge of the cover layer 122 is far away from a right edge of the substrate, such that when the composite structure is used as a slide for preparation and analysis of a sample, the composite structure can provide an enough area to support the sample.

In addition, even though the composite structure according to embodiments of the present disclosure has an additional cover layer as compared with an existing slide which only includes a substrate and a lacquer layer, as the cover layer is thin, smooth, and highly transparent, the printing performance of the composite structure is comparable to that of the existing slide, which can be seen from the comparison results displayed in FIG. 6, where the slide at the left end is an existing slide, while the slide at the right end is one made according to embodiments of the present disclosure. As can be seen from FIG. 6, they have almost the same printing effects. Therefore, the composite structure according to embodiments of the present disclosure has a good printing performance.

In the specification, it is to be understood that terms such as “central,” “longitudinal,” “lateral,” “length,” “width,” “thickness,” “upper,” “lower,” “front,” “rear,” “left,” “right,” “vertical,” “horizontal,” “top,” “bottom,” “inner,” “outer,” “clockwise,” and “counterclockwise” should be construed to refer to the orientation as then described or as shown in the drawings under discussion. These relative terms are for convenience of description and do not require that the present disclosure be constructed or operated in a particular orientation.

In addition, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present disclosure, “a plurality of” means two or more than two, unless specified otherwise.

Terms used herein in the description of the present disclosure are only for the purpose of describing specific embodiments, but should not be construed to limit the present disclosure. As used in the description of the present disclosure and the appended claims, “a” and “the” in singular forms mean including plural forms, unless clearly indicated in the context otherwise. It should also be understood that, as used herein, the term “and/or” represents and contains any one and all possible combinations of one or more associated listed items. It should be further understood that, when used in the specification, terms “comprising” and/or “containing” specify the presence of stated features, operations, elements and/or components, but do not exclude the presence or addition of one or more other features, operations, elements, components and/or groups thereof.

In the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on,” “above,” or “on top of” a second feature may include an embodiment in which the first feature is right or obliquely “on,” “above,” or “on top of” the second feature, or just means that the first feature is at a height higher than that of the second feature; while a first feature “below,” “under,” or “on bottom of” a second feature may include an embodiment in which the first feature is right or obliquely “below,” “under,” or “on bottom of” the second feature, or just means that the first feature is at a height lower than that of the second feature.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples. In addition, in the absence of contradiction, those skilled in the art can combine the different embodiments or examples described in this specification, or combine the features of different embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. A composite structure, comprising:
a substrate, and
a printable layer, provided on at least a part of a surface of the substrate and having accommodated therein a colorful material.

2. The composite structure according to claim 1, wherein
the colorful material is covered by the printable layer, or
the colorful material is dispersed in the printable layer.

3. The composite structure according to claim 1- or 2, wherein the printable layer comprises:
a coating layer, comprising the colorful material and provided on the at least a part of the surface of the substrate; and
a cover layer, comprising a transparent material and provided on a surface of the coating layer opposite to the substrate.

4. The composite structure according to claim 3, wherein an orthographic projection of the coating layer on the surface of the substrate is overlapped exactly with that of the cover layer on the surface of the substrate.

5. The composite structure according to claim 3, wherein an orthographic projection of the coating layer on the surface of the substrate is within that of the cover layer on the surface of the substrate.

6. The composite structure according to claim 5, wherein at least a part of a periphery of the cover layer extends beyond the coating layer to the surface of the substrate.

7. The composite structure according to claim 5, wherein at least a part of a periphery of the cover layer extends to cover a thickness direction of the substrate.

8. The composite structure according to claim 3, wherein at least a part of a periphery of the coating layer is aligned with or close to a corresponding part of a periphery of the substrate.

9. The composite structure according to claim 1, wherein the printable layer is aligned with or close to a first end of two opposite ends of the substrate, and is far away from a second end of the two opposite ends of the substrate.

10. The composite structure according to claim 3, wherein the transparent material is one or more selected from the group consisting of a UV glue, a silicone oil, glass, and a thermoplastic.

11. The composite structure according to claim 3, wherein the cover layer is adhered to the coating layer.

12. The composite structure according to claim 1, wherein the colorful material has a light color.

13. The composite structure according to claim 1, wherein the substrate is transparent.

14. A method for producing a composite structure, comprising:
providing a substrate; and
providing a printable layer on at least a part of a surface of the substrate,
wherein the printable layer has accommodated therein a colorful material.

15. The method according to claim 14, wherein providing the printable layer on at least a part of the surface of the substrate comprises:
dispersing the colorful material in a transparent material; and
painting a mixture of the colorful material and the transparent material on at least a part of the surface of the substrate.

16. The method according to claim 14, wherein the printable layer comprises a coating layer and a cover layer, and wherein providing the printable layer on at least a part of the surface of the substrate comprises:
providing the colorful material on the at least a part of the surface of the substrate to form the coating layer; and
providing the transparent material on a surface of the coating layer opposite to the substrate to form the cover layer.

17. A method of using the composite structure according to claim 1 in laser printing, comprising:
illuminating a part of the colorful material contained in the printable layer, by a laser of a laser printing system, to ablate the part of the colorful material contained in the printable layer and thereby generate printed content.

18. The method according to claim 17, wherein the laser printing system is an infrared laser printing system or a UV laser printing system.

19. The composition structure according to claim 1, wherein the colorful material has a white, pink, yellow or green color.

20. The composition structure according to claim 1, wherein the substrate is a glass substrate or a plastic substrate.
